(19) United States
(12) Patent Application Publication
(10) Pub. No.: US 2015/0143778 A1
(43) Pub. Date: May 28, 2015

(54) APPARATUS AND METHOD FOR FILLING, CLOSING AND LABELLING CONTAINERS

(71) Applicant: KRONES AG, Neutraubling (DE)

(72) Inventors: Heinz Humele, Thalmassing (DE); Horst Winter, Neutraubling (DE)

(73) Assignee: KRONES AG, Neutraubling (DE)

(21) Appl. No.: 14/368,877

(22) PCT Filed: Dec. 19, 2012
(86) PCT No.: PCT/EP2012/076190

§ 371 Date: Oct. 14, 2014

(30) Foreign Application Priority Data
Dec. 29, 2011 (DE) 10 2011 057 112.4

(51) Int. Cl. B67C 7/00; B65C 9/02; B65C 3/14

(52) U.S. Cl. CPC B67C 7/004; B65C 3/14; B65C 9/02
USPC 53/415; 53/136.1

(57) ABSTRACT

An apparatus for the treatment of containers (10), with a movable carrier (2) for conveying the containers to be treated, with a plurality of treatment units (4, 6, 8) which treat each container (10) in a pre-set manner, wherein the treatment units (4, 6, 8) of a first group of these treatment units (4, 6, 8) are filling units (4) which fill the containers (10) with a flowable medium, and these filling units (4) have in each case filling elements (14) which are arranged on the carrier (2) and which move jointly with the containers (10) at least sectionwise, wherein the treatment units (4, 6, 8) of a second group of these treatment units (4, 6, 8) are labelling devices (6) which apply labels to the containers (10), and wherein the treatment units (4, 6, 8) of a third group of these treatment units (4, 6, 8) are closing units (8) which close with a closure the containers (10) filled with the flowable medium and which have in each case closure elements (18) which are arranged on the carrier (2) and which move jointly with the containers (10) at least sectionwise. According to the invention the treatment units (4, 6, 8) are arranged with respect to the carrier (2) in such a way that the filling of the containers by the first filling units (4), the labelling of the containers (10) by the labelling units (6) and the closing of the containers (10) by the closing units (8) take place during a conveying of the containers (10) by means of one movable carrier (2).

The present invention relates to an apparatus and a method for the filling, closing and labelling of containers. In the beverage-producing industry it has long been known for containers, for example plastics material containers, to be filled and then closed and, in addition, also provided with labels. In this case it is usual for a plurality of units adjoining one another to be provided, for example a filling means which fills the containers, a closing means which is arranged downstream of this filling means and which closes the containers with closures, and a labelling unit which applies labels to the outer wall of the containers.

In addition, apparatus are known in which a labelling of the containers is first carried out and only after that a filling of the containers is carried out, as well as apparatus in which the filled, but still not closed, containers are labelled.

In addition, apparatus which combine the individual method steps are known from the prior art.

An apparatus for the filling of containers is known from DE 39 27 489 A1. In this case, containers are filled during the conveying thereof and are labelled by means of further container treatment devices, such as labelling devices, arranged along a container path or are printed by means of printing devices.

WO 2005/058734 A1 describes a method and an apparatus for the manipulation of receptacles, in which a path in the conveying direction of these receptacles between a run-in and a run-out station is designed in the form of a multiple passage path. In this way, a plurality of testing procedures can be carried out for example on the respective receptacles during the passage through this path.

FR 2 576 003 describes a method and an apparatus for subjecting articles to a multiplicity of treatment steps of the same treatment unit.

A method and an apparatus for the production of a labelled plastic bottle is known from DE 198 06 647 A1. In this case a blow moulding station for the shaping of plastics material pre-forms into plastics material containers is provided, upstream of which an apparatus for labelling plastics material pre-forms is arranged.

The object of the present invention is to make apparatus of this type still more compact as compared with the prior art. This is achieved according to the invention by an apparatus and a method according to the independent claims. Advantageous embodiments and further developments form the subject matter of the sub-claims.

An apparatus according to the invention for the treatment of containers has a movable carrier for conveying the containers to be treated as well as a plurality of treatment units which treat each container in a pre-set manner. In this case the treatment units of a first group of the treatment units are filling units which fill the containers with a flowable medium, preferably a liquid and, in particular, a beverage. In this case these filling units have in each case filling elements which are arranged on the carrier and which move jointly with the containers at least sectionwise. In addition, the treatment units of a second group of these treatment units are labelling devices which apply labels to the containers, and the treatment units of a third group of these treatment units are closing units which close with a closure the containers filled with the flowable medium and which have in each case closure elements which are arranged on a carrier and which move jointly with the containers at least sectionwise.

According to the invention the treatment units are arranged with respect to the carrier in such a way that, the filling of the containers by the first filling units, the labelling of the containers by the labelling units and the closing of the containers by the closing units take place during a conveying of the containers by means of this one movable carrier. It is preferable for the carrier to serve as a conveying device for the conveying of the containers.

A combined machine is thus proposed, therefore, which both fills and closes the containers, and also provides them with labels. In this case the labelling can take place before or after the filling or even after the closing of the containers. In contrast to machines known from the prior art, the containers are filled, labelled and closed in this case while they are conveyed with the aforesaid carrier.

In this way, it is possible for example for the filling units to be arranged on the carrier in a fixed manner in each case and for the filling units also preferably to have conveying elements or gripping elements respectively which hold the containers while the containers are being filled. In a corresponding manner, the closure units can also be arranged on the carrier in a fixed manner and can hold or guide the containers respectively while the latter are closed with a closure. In addition, the labelling units can be arranged at least in part on the carrier in a fixed manner in this case. It would also be possible, however, for the labelling units to be arranged so as to be stationary for example about an external periphery of the carrier in order to label the containers.

The present invention further relates to an apparatus for the treatment of containers with a movable carrier, this carrier being used for the conveying of the containers to be treated and having a plurality of treatment units which treat each container in a pre-set manner. In this case the treatment units of a first group of these treatment units are filling units which fill the containers with a flowable medium. These filling units have in each case filling elements which are arranged on a carrier and which move jointly with the containers at least sectionwise. In addition, the treatment units of a second group of these treatment units are labelling devices which apply labels to the containers.

According to the invention the treatment units are arranged with respect to the carrier in such a way that the filling of the containers by the first filling units and the labelling of the containers by the labelling units are performed during a conveying of the containers by means of a movable carrier. In addition, the apparatus has a closing unit for the closing of the containers with closures, this apparatus having for closing purposes a plurality of closing units which close with a closure the containers filled with the flowable medium and these closing units are arranged in such a way that the containers filled by the filling units are first closed by the closing units and are then labelled by the labelling devices.

In the case of this design it is therefore provided that the closing units are not necessarily present on the movable carrier, but are separate therefrom, for example on a separate closing unit. It is advantageous in the case of this design for the empty containers first to pass through the apparatus mentioned above and to be filled during this. After that, the containers are transferred to the closing means by way of a conveying device, such as a conveying star wheel, and are provided with closures there. After that, the closed containers are transferred again to the apparatus mentioned above and are provided with labels there.

It is therefore advantageous for at least one conveying means, which transfers the containers to the closing unit, to be provided between the movable carrier and the closing device. It is advantageous for a second conveying means or a second conveying unit respectively, which transfers the closed containers to the combined filling and labelling unit again, also to be provided.

It is advantageous for one of the two conveying devices, preferably for both of the conveying devices to be a distribution delay star wheel and/or a multiple-function star wheel.

In the case of a further advantageous embodiment the closing device has a carrier which is smaller with respect to diameter as compared with the filling device. This takes into consideration the fact that such a large diameter, such as for example in the case of a filling machine, is not necessary for the closing means.

In this case it is also possible here for the containers to be brought to a division of the filling device by an infeed worm for example and to be transferred to a run-in star wheel. The containers are filled and are conveyed in the run-out star wheel and are then passed by the same star wheel to the closing device. After the containers have been closed, they are again brought into the division of the labelling machine by the run-in star wheel which is advantageously a distribution delay star wheel.

After the containers have been labelled, the run-out star wheel, which also serves to supply the containers to the closing device, passes the containers to the run-out.

It is advantageous for the apparatus to be a machine which operates continuously, i.e. the containers are moved continuously during the treatment procedures. It would also be possible, however, for the machine to be designed in the form of a clock time machine which conveys the containers in a clock-timed manner.

In the case of a further advantageous embodiment the carrier is a carrier rotatable about a pre-set axis of rotation. In this way, the machine can be designed for example in the form of a rotary machine, in which case the filling units and/or the closing units are arranged on a corresponding rotatable carrier in the manner of a filling turntable or closing turntable respectively.

In the case of a further advantageous embodiment the treatment units are arranged on or with respect to the carrier in such a way that each container is conveyed at least twice by the carrier (in particular along a substantially equal conveying path) in order to be filled, labelled and closed. In this way it would be possible for the containers to be filled and closed in a first revolution on or by means of the carrier and labelled in a second revolution.

It would also be possible, however, for the containers to be filled and labelled in a first revolution and to be closed in a second revolution. Finally, it would also be possible for the containers to be filled in a first revolution with the carrier and to be closed and labelled in a second revolution. In this way, it is advantageous for the containers to circulate exactly twice with the aforesaid carrier. It would also be possible, however, for the three treatments, namely the filling and closing and labelling, to be carried out in three revolutions with the carrier.

In the case of a further advantageous embodiment the filling units and the closing units are arranged offset from one another on the carrier. In this way, it is possible for a plurality of treatment units to be arranged as a whole on the carrier, in which case the filling units and the closing units (and optionally also the labelling units) are arranged one behind the other in each case on the carrier. This sequence can also, however, be arranged in a different manner. In this way, it would be possible for the same number of filling units, closing units and labelling units to be arranged as a whole on the carrier in each case and for them to be arranged in a pre-set sequence one behind the other on the carrier in each case. It would also be possible, however, for individual treatment units to be for example combined filling and closing units.

It would likewise be possible for treatment units of this type to be interchanged, preferably for labelling units to be interchanged, and in particular for the provision of the containers with labels in a different manner.

In the case of a further advantageous embodiment the labelling units are arranged so as to be stationary at least in part with respect to the carrier and, in particular, radially outside the external periphery of the carrier. In this case it is also possible for these labelling units to be subdivided in turn into different groups, so that, depending upon the requirements of the customers, various labels can also be applied to the containers. In other words it is advantageous for the labelling units to be interchangeable.

In the case of a further advantageous embodiment, containers treated in different ways are capable of being supplied to the carrier. In this way, it is possible for totally non-treated containers, i.e. containers which are empty and not labelled, first to be supplied to the carrier and for containers which are already filled or closed or labelled respectively to be supplied in a subsequent revolution.

In the case of a further advantageous embodiment the apparatus has a supply device which supplies the containers to the carrier as well as a first and a second supply unit which supply the containers to this supply device in each case. This supply unit can be for example a supply star wheel which supplies the containers to the carrier. In this case this supply star wheel can be supplied for example by a further star wheel with empty and non-labelled containers and at the same time by a further star wheel with containers already treated in a pre-set manner, for example filled containers.

In this case this supply device advantageously has a plurality of controllable holding elements or gripping elements respectively for the holding or gripping respectively of the containers. In this way, each individual gripping element can be controlled individually, for example it can be opened and closed in order to take on a container. In this way, it is possible for the containers to be transferred in a pre-set manner (and preferably also sequence) to the supply device and from there to the carrier device. This means that containers are preferably conveyed from the supply device already at different treatment stages.

In the case of a further advantageous embodiment the apparatus has at least one distribution changing device which changes a distribution between the individual containers during the conveying thereof. In this way, it is possible for example for an infeed worm wheel, which brings the containers to the distribution of the carrier, to be provided already upstream of the supply device or the run-in star wheel respectively. In addition, the further supply unit mentioned above can also be designed for example in the form of a distribution delay star wheel which changes a distribution between the individual containers in order to adapt the distribution of the containers in this way to a further treatment step such as for example the closing. In this way, the apparatus advantageously has two or more distribution changing devices of this type, in which case it is possible for these distribution changing devices, as mentioned above, to be for example infeed worm wheels or distribution delay star wheels.

In this way, it is also advantageous for a distribution changing device to be provided which conveys containers already treated in a pre-set manner (i.e. in particular already conveyed by the conveying device) back to the carrier.

The present invention further relates to a method of treating containers with a plurality of treatment units, in which the containers are conveyed during the treatment thereof at least in part by means of a carrier and the containers are filled with a flowable medium by filling units which are a first group of these treatment units and have filling elements which are arranged in each case on the carrier and which move jointly with the containers at least sectionwise. After the filling with the flowable medium the containers are closed with a closure by closing units which are a second group of these treatment units and have closing elements which are arranged in each case on a carrier and which move jointly with the containers at least sectionwise. In addition, labels are applied to the containers by means of labelling units which are a third group of these treatment units.

According to the invention the filling of the containers is carried out by the filling units, the labelling of the containers is carried out by the labelling units and the closing of the containers is carried out by the closing units during a conveying of the containers by means of a movable carrier.

It is therefore also proposed with respect to the method that the containers are subjected during the conveying with the aforesaid carrier to the at least three aforesaid treatment steps, namely filling, closing and labelling. In addition, still further treatment steps can be carried out, such as for example a sterilization of the containers or even leakage tests and the like.

It is advantageous for the containers to be conveyed during the treatment thereof by the treatment units at least twice by means of the carrier.

In this way, the carrier advantageously conveys containers at the same time at least for a time in different treatment stages, for example non-treated containers, in order to fill them, and at the same time already filled containers, in order to close them, or even already filled and closed containers, in order to label them and the like.

In the case of a further advantageous method a distribution between the containers is changed at least once during the treatment. In this way it is possible for the distribution of the containers to be changed after the filling thereof, in order to adapt the distribution to the distribution of individual closing units. Further advantages and embodiments are evident from the accompanying drawings. In the drawings

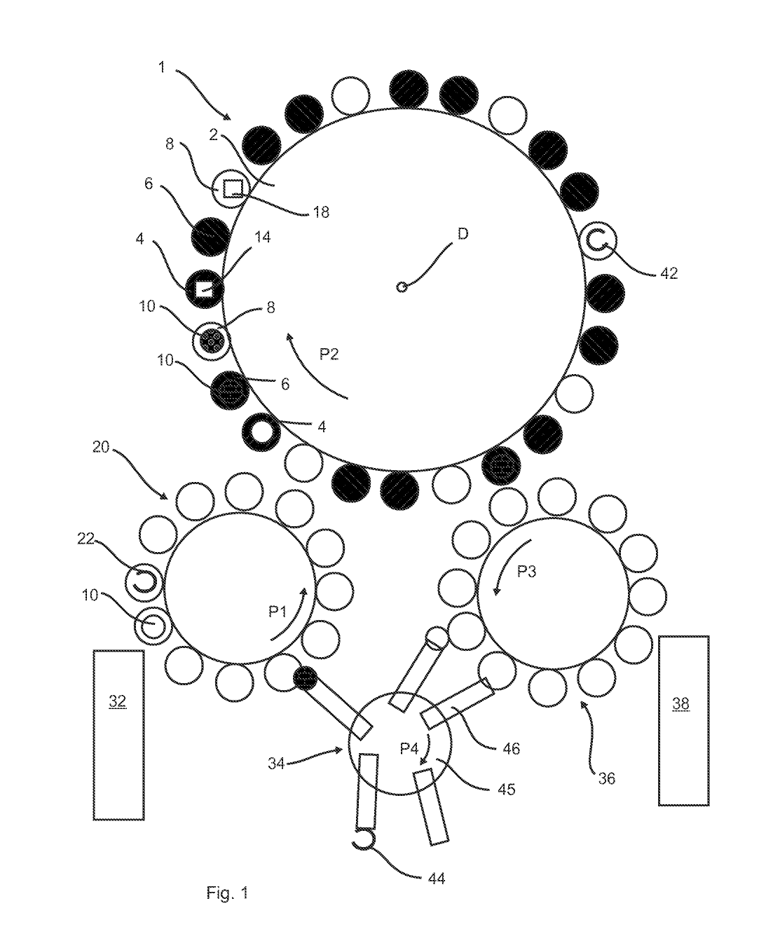

FIG. 1 is a roughly diagrammatic illustration of an apparatus in a first embodiment;

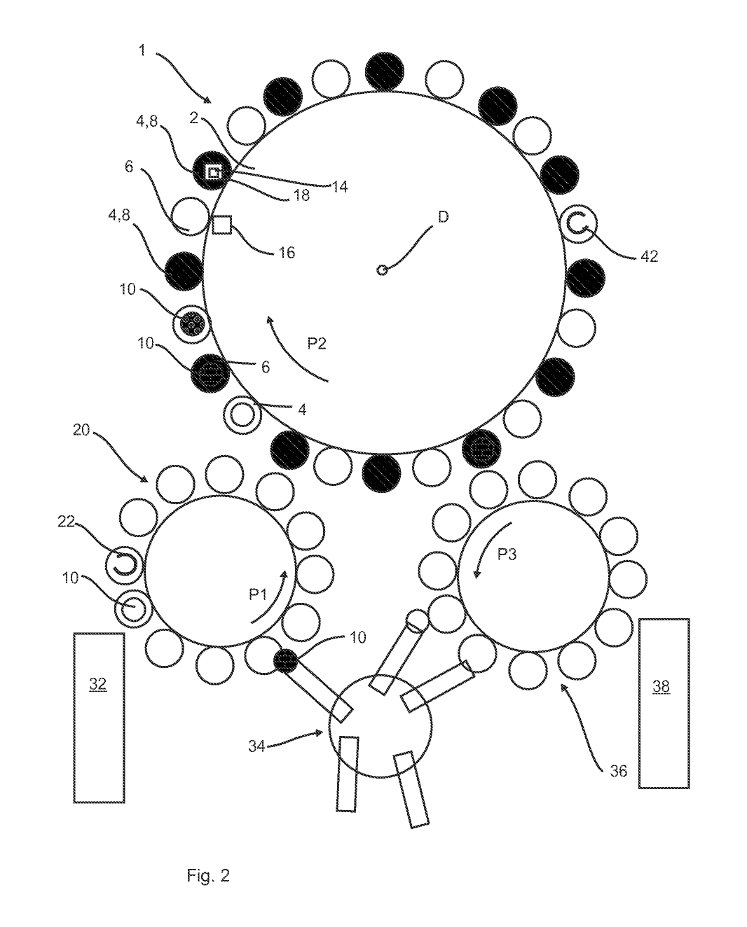

FIG. 2 is a roughly diagrammatic illustration of a further embodiment according to the invention;

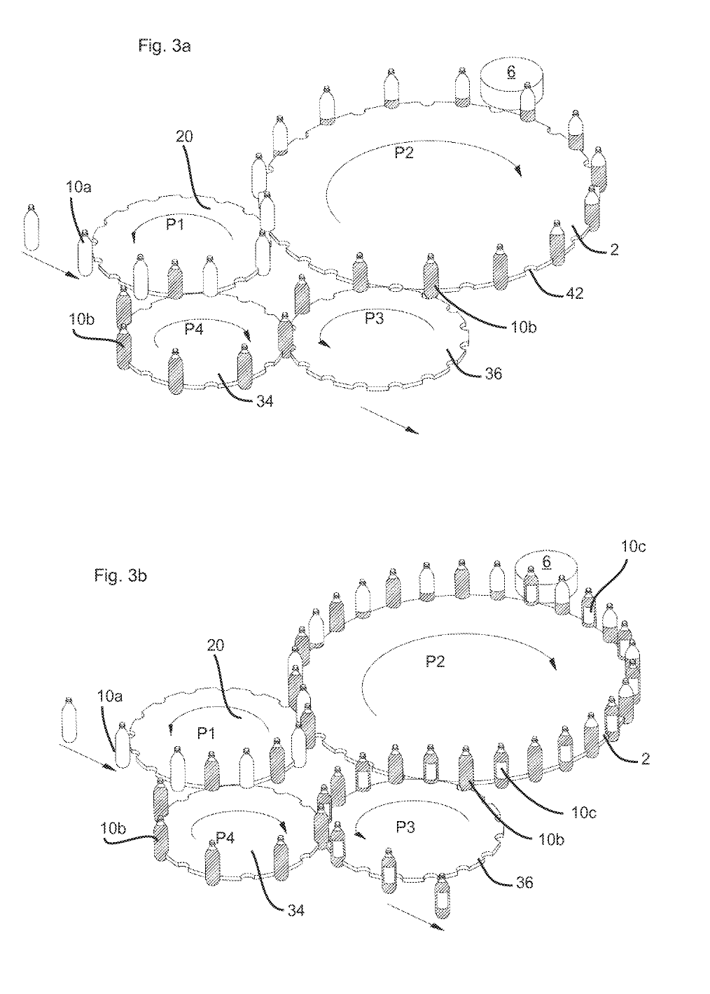

FIGS. 3a, b are two illustrations to demonstrate a method according to the invention, and

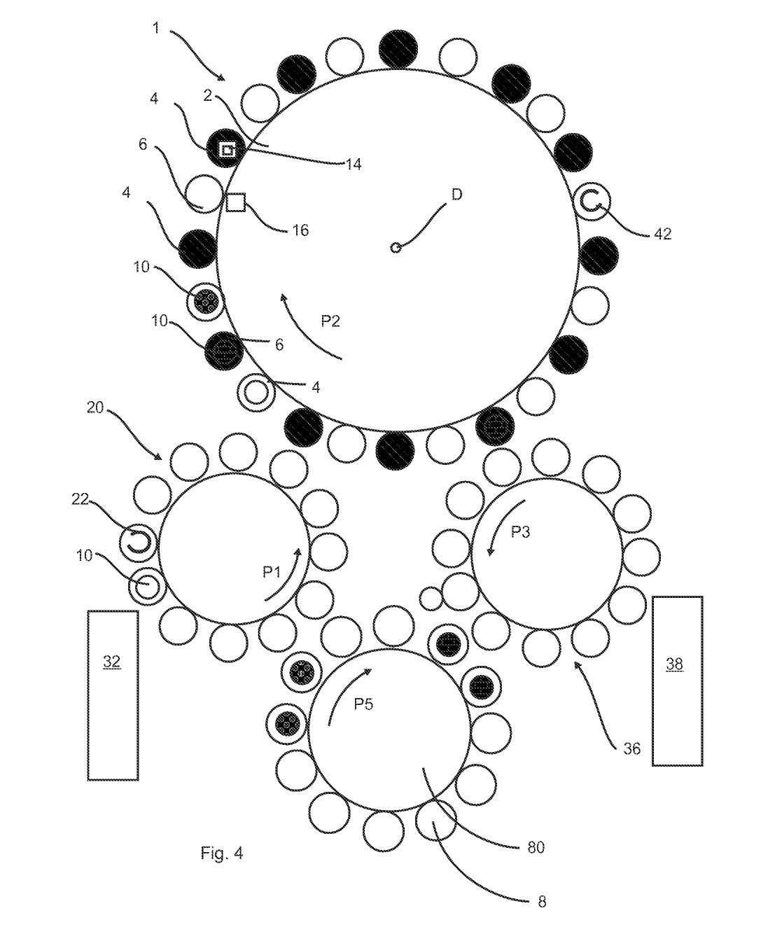

FIG. 4 is an illustration of a further treatment apparatus for containers.

FIG. 1 shows a first embodiment of an apparatus 1 according to the invention. This apparatus 1 according to the invention for the treatment of containers has in this case a carrier 2 which also serves as a conveying device for the container and on which are arranged a plurality of treatment units 4, 6, 8. The treatment units 4 are filling devices which are not shown in detail and which fill the containers with a liquid. The treatment units 8 are closing stations which provide the containers with closures, for example they screw closures onto these containers. The treatment units 6 are labelling units which provide the containers with labels. The reference number 18 designates closing elements, such as for example closing heads which screw the closures onto the containers. The reference number 14 designates filling elements which fill the containers in each case.

The carrier 2 or the conveying device respectively is arranged in this case so as to be rotatable about an axis of rotation D. The individual treatment units can be arranged equidistantly in the peripheral direction of the carrier in this case. The reference P2 designates the conveying direction of the containers during the conveying thereof on the carrier or during the conveying thereof with the treatment units arranged on the carrier respectively.

The containers 10 are likewise shown differently, depending upon the treatment state thereof. The containers 10 represented by empty circles designate containers which are not yet treated and which are neither filled nor closed, nor labelled. The circles filled with points designate containers which are already filled and already closed, and the circles provided with a building block pattern designate containers which are filled but not yet closed or labelled.

In this way, in the case of the embodiment shown in FIG. 1 the containers are filled in a first passage, are closed in a second revolution and are provided with labels in a third revolution with the carrier 2 or the conveying device respectively. As mentioned above, however, the sequence can also be arranged differently, so that first of all a first revolution takes place in which the containers are filled, after that a second revolution in which they are labelled, and finally a third revolution in which they are closed. In addition, it would be possible for the containers first to be labelled, then filled and then closed. In this way, any desired sequences are provided in principle, in which case, however, the containers are filled first and closed only after that.

The supply device 20 has a plurality of controllable gripping elements 22 which grip the containers 10 for the purpose of conveying the latter along the arrow P1. In the case of the design shown in FIG. 1 only every third gripping element is supplied with containers by the supply unit 32. This supply unit 32 can be an infeed worm wheel which brings the containers to a pre-set distribution.

The containers already treated in a pre-set manner are then transferred back again to the run-in star wheel 20 by way of a run-out star wheel 36 and a transfer star wheel 34. In this way, it is possible for example for containers which have been filled, but not yet closed or labelled, to be conveyed to the run-in star wheel 20 by way of the transfer star wheel 34. This transfer star wheel 34 is in this case for example a distribution delay star wheel by which the distribution between the individual containers can be changed.

In the case of the design shown in FIG. 1, the empty gripping elements 22 are now provided with containers, so that as a whole the containers are conveyed on the run-in star wheel 20 in a plurality of different treatment stages and can be transferred accordingly to the carrier 2. In addition, the transfer star wheel 34 can have in this case a gripping element, and in particular a plurality of gripping elements, 44 which serve to hold and convey the containers. In this way, it is preferable for the containers to be guided preferably separated through the entire apparatus. Furthermore, in a possible embodiment the transfer star wheel 34 has a plurality of arms 46 which are pivotable with respect to a carrier 45 and on which are arranged the individual gripping elements 44.

The reference number 38 designates (again only roughly diagrammatically) a removal device which removes the ready treated containers, i.e. the containers which are filled and closed as well as labelled. It will be seen that in the case of the embodiment shown in FIG. 1 the treatment stations 4, 6, 8 are arranged in an alternating manner in each case on the carrier 2. It would also be possible, however, in particular for the labelling units 6 to be arranged not on the carrier 2 itself but in the vicinity thereof, in order to provide the individual containers with labels. It is pointed out that the individual treatment stations 4, 6, 8 are illustrated only roughly diagrammatically in each case. It would also be possible in this case for some individual treatment units (for example the filling units 4) to be offset with respect to other treatment units in the radial direction of the carrier.

It is therefore advantageous for the containers to remain on a specified treatment station 4, 6, 8 during a specified revolution on the carrier.

FIG. 2 shows a further embodiment of an apparatus 1 according to the invention. In the case of this embodiment the filling units 4 and the closing units 8 are combined in each case to form a common treatment station 4, 8, so that in this case two types of treatment stations are arranged in an alternating manner on the carrier 2. This means that in the case of the variant shown in FIG. 2 the containers are conveyed only twice by the carrier 2 along their conveying path P, whereas in the case of the embodiment shown in FIG. 1 the containers are conveyed three times along the conveying path P2. The arrows P1 to P4 indicate as a whole the conveying path of the containers. The reference number 42 designates gripping elements of the carrier 2.

It would also be possible for the individual containers to be subjected to all three treatment steps during a passage on the carrier 2, in which case each individual treatment unit is provided in combination as a labelling station, as a filling device and as a closing device.

FIGS. 3a and 3b show two further illustrations to demonstrate the method according to the invention. The filling units and the closing units are not shown in this case. In the case of the situation shown in FIG. 3a empty containers 10a are supplied to the conveying device 2 and, as shown in FIG. 3a, are filled during this conveying. The filled containers are then provided with closures during this passage on the conveying device 2 and are then conveyed (already closed) back to the run-in star wheel 20 by way of the run-out star wheel 36 and the transfer star wheel 34 (arrow P4). The transfer star wheel 34 is not designed in the form of a distribution delay star wheel in this case.

On the run-in star wheel only every second gripping element has been provided with empty containers 10a. The respective free gripping elements remaining are then provided with the filled and closed containers 10b.

These containers 10b are, as shown in FIG. 3b, transferred to the conveying device again and are labelled there by the labelling unit 6 during their second revolution. The containers closed and labelled accordingly are provided with the reference number 10c and are removed by way of the run-out star wheel 36.

FIG. 4 shows a further embodiment of an apparatus according to the invention. In the case of this embodiment the closing units are not on the carrier 2 but on a further closing unit 80. This closure unit 80 can take on the already filled containers from the run-out star wheel 36 in this case and close the containers with closures in the course of the conveying with the unit 80. The closed containers are then transferred to the carrier 2 again by way of the run-in star wheel or supply device respectively and are then labelled by the labelling units 6. In addition, with this design both the filling of the containers and the labelling of the containers are carried out with the same unit and only the closing is carried out with the closing unit 80 which is coupled to the filling and labelling unit by way of the run-out and run-in star wheels mentioned. In this embodiment too, the run-in star wheel 20 serves both to convey the still empty and not labelled containers and to convey the already filled and closed containers. The run-out star wheel 36 preferably serves in this case both for conveying the containers which are only filled but not yet closed and not labelled, and for conveying the containers which are filled, labelled and closed. As mentioned, it is possible in this case for the run-in star wheel or supply device 20 respectively and/or the run-out star wheel 36 to be designed in the form of distribution delay star wheels or, on the other hand, also in the form of so-called multiple-function star wheels. In addition, a relatively small distribution between the individual containers 10 on the apparatus 1 is made possible by this procedure.

The Applicants reserve the right to claim some or several of the features disclosed in the application documents either individually or in combination, insofar as these features are novel as compared with the prior art.

### LIST OF REFERENCES

1 apparatus
2 carrier, conveying device
4 treatment units (filling units)
6 treatment units (labelling units)
8 treatment units (closing units)
10 containers
10a empty containers
10b filled and closed containers
10c filled, closed and labelled containers
14 filling elements
18 closing elements
20 run-in star wheel, supply device
22 gripping elements
32 supply device
34 transfer star wheel
36 run-out star wheel
38 removal device
42 gripping elements of the conveying device 2
44 gripping elements of the transfer star wheel 34
45 carrier of the transfer star wheel
46 pivotable arms
80 unit
P1 to P5 conveying path of the containers

1.-12. (canceled)

13. An apparatus for processing containers, comprising:
a movable carrier for conveying the containers;
a plurality of filling units in communication with the movable carrier, the filling units constructed and arranged to fill the containers with a flowable medium during the conveying of the containers;
a plurality of labelling devices in communication with the movable carrier, the labelling devices constructed and arranged to apply labels to the containers during the conveying of the containers; and
a plurality of closing units in communication with the movable carrier, the closing units constructed and arranged to close the containers filled with the flowable medium during the conveying of the containers.

14. An apparatus according to claim 13, wherein the carrier is rotatable about a pre-set axis of rotation.

15. An apparatus according to claim 13, wherein the filling units, the labelling devices, and the closing units communicate with the carrier in such a way that each container is conveyed at least twice by the carrier in order to be filled, labelled and closed.

16. An apparatus according to claim 13, wherein the filling units and the closing units are arranged offset from one another on the carrier.

17. An apparatus according to claim 13, wherein the labelling units are stationary with respect to the movable carrier.

18. An apparatus according to claim 13, wherein the labelling units are interchangeable.

19. An apparatus according to claim 13, wherein containers treated in different ways are supplied to the carrier.

20. An apparatus according to claim 13, further comprising a supply device that supplies the containers to the carrier.

21. An apparatus according to claim 20, further comprising a first supply unit and a second supply unit that supply containers to the supply device.

22. An apparatus according to claim 13, further comprising at least one distribution changing device which changes a distribution between the containers.

23. An apparatus according to claim 13, wherein the filling units comprise filling elements which are constructed and arranged on the carrier and which move jointly with the containers at least sectionwise.

24. An apparatus according to claim 13, wherein the closing units comprise closure elements which are constructed and arranged on the carrier, and which move jointly with the containers at least sectionwise.

25. An apparatus according to claim 13, wherein each filling unit, labelling device, and closing unit is coupled to the movable carrier.

26. An apparatus according to claim 13, wherein at least one of the filling units, the labelling devices, and the closing units is separate from and in communication with the movable carrier and the remainder of the filling units, the labelling devices, and the closing units is coupled to the movable device.

27. A method of treating containers, comprises:
conveying, by a movable carrier, the containers;
filling, by treatment units, the containers with a flowable medium during the conveying of the containers;
labelling, by the treatment units, the containers during the conveying of the containers; and
closing, but the treatment units, the containers filled with the flowable medium during the conveying of the containers.

28. A method according to claim 27, wherein the containers are conveyed during the treatment by the treatment units at least twice in each case by means of the carrier.

29. A method according to claim 27, wherein a distribution between the containers is changed at least once during the treatment thereof.

30. A method according to claim 27, wherein each filling unit, labelling device, and closing unit is coupled to the movable carrier.

31. A method according to claim 27, wherein at least one of the filling units, the labelling devices, and the closing units is separate from and in communication with the movable carrier and the remainder of the filling units, the labelling devices, and the closing units is coupled to the movable device.

32. A method according to claim 27, wherein the filling units comprise filling elements which are constructed and arranged on the carrier and which move jointly with the containers at least sectionwise, and wherein the closing units comprise closure elements which are constructed and arranged on the carrier, and which move jointly with the containers at least sectionwise.
